(19) United States
(12) Patent Application Publication
(10) Pub. No.: US 2013/0185457 A1
(43) Pub. Date: Jul. 18, 2013

(54) Command API Using Legacy File I/O Commands for Management of Data Storage

(71) Applicant: Greg Campbell, Bloomfield Township, MI (US)

(72) Inventor: Greg Campbell, Bloomfield Township, MI (US)

(73) Assignee: YOTTABYTE LLC, Bloomfield Township, MI (US)

(21) Appl. No.: 13/352,192

(22) Filed: Jan. 17, 2012

(51) Int. Cl. G06F 3/00

(52) U.S. Cl. 710/5

(57) ABSTRACT

Methods and systems are disclosed that relate to file management operations. One method includes receiving from a first computing device at a target computing device a command string including a command and a path. The command is defined in a set of commands recognizable on the first computing device and the path is associated with the command and indicating execution on the target computing device, the path including a modifier. The method also includes, in response to receiving the command string, interpreting the command as a second command recognizable on the target computing device but not provided by a set of command supported by the first computing device. The second command is defined at least in part by the modifier. The method further includes performing the second command at the target computing device.

### TECHNICAL FIELD

The present application relates generally to data storage techniques. In particular, the present application relates to use of a command API using legacy file I/O commands for management of data storage.

### BACKGROUND

Over the past few decades a multitude of manufacturers have offered many different types of computer systems. Many of these manufactures have developed and released their own operating systems (OS's). This presented a challenge to software application developers. If a developer wished to have their application run on more than one type of computer system, the application needed to be extended with systems compiler switches that provided alternative runtime configuration options to access different system resources, such as different file systems/storage, different communications interfaces, and different user interfaces.

To address this challenge, standards were created that allowed for portability across computing systems. For example, a set of Application Programming Interfaces (API's) were defined to allow access to external computer systems, internal systems resources and the user interface. The POSIX (Portable Open System Interface for UNIX) is the most widely used of these standards.

POSIX is a range of standards that help to provide compatibility and interoperability of applications in environments with different operating systems on a multitude of hosts. These hosts can consist of computers from different manufacturers, as well as system and application software from different software providers. The POSIX standard was defined as the national American standard by the Institute of Electrical and Electronics Engineers (IEEE) in 1989. It has since been modified; the latest version is the POSIX.1 standard: IEEE Std 1003.1 2008 Edition. POSIX.1 is also an international standard: ISO/IEC publication occurred in September 2009 and is designated ISO/IEC 9945:2009.

POSIX has addressed the need for portability of applications between computer systems. However, POSIX has drawbacks. For example, POSIX does not address all the different types of ways to leverage system resources for a variety of purposes.

Operating system manufacturers and database management system vendors continue to develop features for their proprietary systems which address needs for advanced data management functions. Advanced data management functions can include, for example, those functions that fall outside of a standard set of legacy data operations, such as those available via POSIX command standards. These can include, for example, systems for providing a storage area network (SAN), replication, encryption, backup, archive, disaster recovery, compliance, or content addressable storage. Additionally, other functions, such as data or system virtualization, data center server functions, branch server functions, WAN acceleration, data deduplication, continuous data protection or search functionality could be provided as well, as part of these advanced, or non-legacy, functions.

In general, all of the above technologies are different methods of formatting and presenting data. Information technology vendors have created a multitude of different hardware and software products to address the various solutions customers require. However, due to the non-standard manner in which these information technology vendors implement these features, systems or applications that interface with the offerings of those vendors must comply with proprietary standards regarding commands used, or in the alternative be limited to a set of basic commands as would be supported in POSIX.

For these and other reasons, improvements are desirable.

### SUMMARY

In accordance with the following disclosure, the above and other issues are addressed by the following:

In a first aspect, a method is disclosed that includes receiving from a first computing device at a target computing device a command string including a command and a path. The command is defined in a set of commands recognizable on the first computing device and the path is associated with the command and indicating execution on the target computing device, the path including a modifier. The method also includes, in response to receiving the command string, interpreting the command as a second command recognizable on the target computing device but not provided by a set of command supported by the first computing device. The second command is defined at least in part by the modifier. The method further includes performing the second command at the target computing device.

In a second aspect, a method is disclosed that includes transmitting from a first computing device to a target computing device a command string, the command string including a command and a path. The command is defined in a set of commands recognizable on the first computing device and the path is associated with the command and indicating execution on the target computing device. The path includes a modifier. By way of the method, the target computing device interprets the command string as a second command and executes the second command, the second command defined at least in part by the modifier and representing one or more file management operations not provided by a set of commands supported by the first computing device.

In a third aspect, a computerized system is disclosed. The computerized system includes a target computing device communicatively interconnected to a first computing device having a memory organized according to a file system, the file system defining a plurality of file I/O commands including a read command, a write command, an open command, a release command, and a stat command. The target computing device is configured to receive one or more command strings including one or more of the plurality of file I/O commands and an associated modifier associated with a path defined on the first computing device defining a directory location on the target computing device. The target computing device includes a second file system including one or more operations not provided by the commands supported by the first computing device, the one or more operations executed by the target computing device in response to receipt of the one or more of the plurality of file I/O commands and associated modifier.

### BRIEF DESCRIPTION OF THE DRAWINGS

FIG. 1 is a schematic view of an example network in which aspects of the present disclosure can be implemented;

FIG. 2 is a schematic view of an example system in which a command AIP using legacy file I/O commands for file management, according to an example embodiment of the present disclosure;

FIG. 3 is a flowchart of a method for performing legacy I/O commands to trigger non-legacy file management commands on a target computing device, according to an example embodiment;

FIG. 4 is a flowchart of a method for performing one or more file management operations on a target computing device, according to an example embodiment;

FIG. 5 is a flowchart of a method for performing data deduplication on a target computing device in response to receiving a legacy file I/O command, according to an example embodiment;

FIG. 6 is a flowchart of a method for performing continuous data protection on a target computing device in response to receiving a legacy file I/O command, according to an example embodiment; and

FIG. 7 illustrates an electronic computing device with which aspects of the just-in-time static translation emulation system can be implemented;

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for performing one or more file management operations that are not available in traditional legacy systems by using those legacy commands as well as a particular path and/or modifier. When the path and/or modifier is received at the particular location supporting the functionality that extends beyond legacy functions, it can be parsed such that one or both of (1) the location and (2) the modifier can dictate the particular non-legacy function that is to be provided relative to that data. Using the methods and systems of the present disclosure, remote systems can access a variety of file management operations simply by using standardized commands that are widely available across all file management systems. In an example embodiment, a user can deliver file management commands from a remote system using POSIX-compliant commands, either from a command line or issued from an application, to a target system capable of receiving those POSIX-compliant commands and performing a broad range of file management operations, defined at least in part based on the path included in the command, or some other type of modifier in the command. These additional file management operations could include, for example, data de-duplication, data protection, replication, content-addressable storage, file encryption, password and storage security key management, or write-once, read-many storage. In some other embodiments discussed herein additional commands could be defined at the target system.

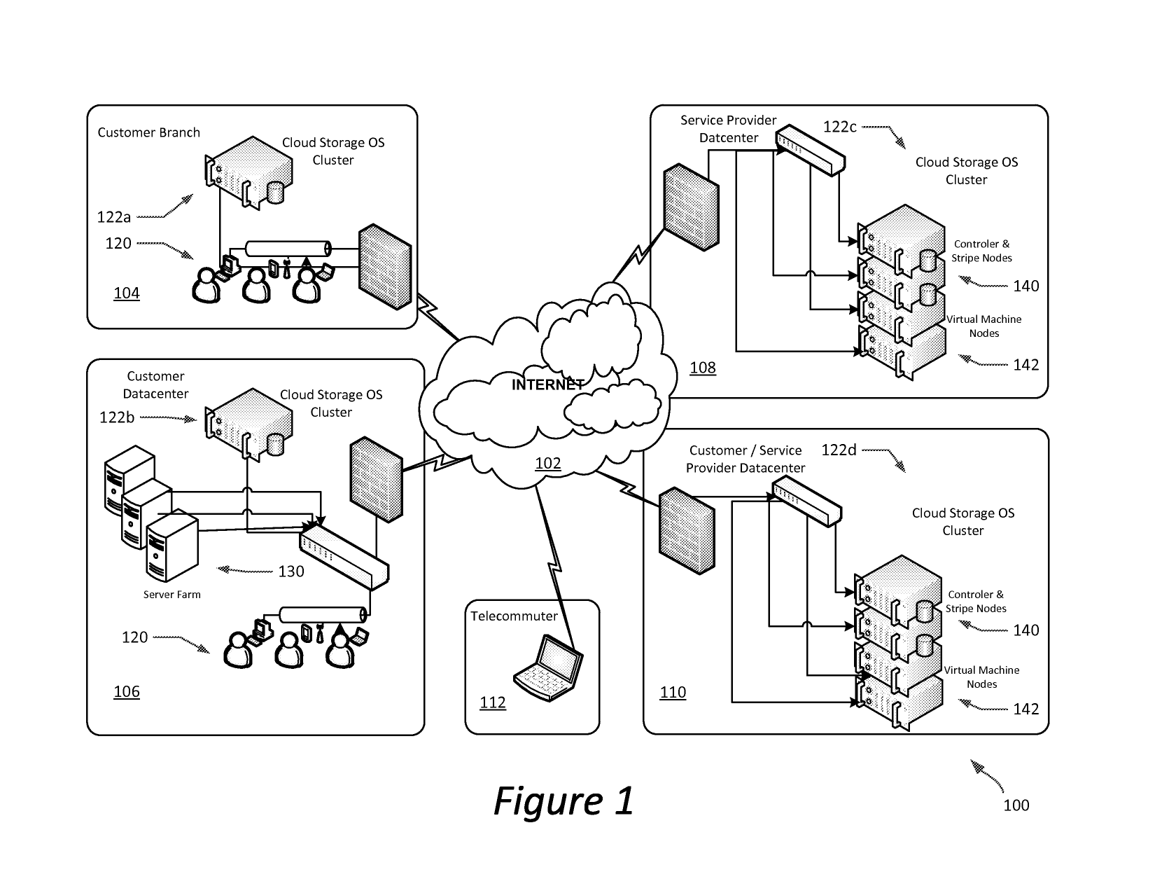

Referring now to FIG. 1, a schematic view of an example network 100 is shown, in which aspects of the present disclosure can be implemented. The network 100 represents an example distributed system in which cloud-based storage services and administration of file storage systems can be provided. In the embodiment shown, the network 100 includes a plurality of file storage locations communicatively interconnected via the internet 102. In the embodiment shown, the file storage locations include a customer branch 104, a customer data center 106, a service provider data center 108, and a hybrid customer/service provider data center 110. The network 100 also includes a telecommuter 112, representing a remote user of file storage.

In the embodiment shown, the customer branch 104 includes data users 120 and a cloud storage cluster 122a. The data users 120 are generally users of computing systems that run one or more applications, and are capable of communicatively connecting to file storage locations within the network 100. The data users 120 typically will include individuals affiliated with the customer (e.g., an individual or organization) who wish to store, access, or organize data owned or accessible to the customer. The cloud storage cluster 122a represents a local storage portion of a cloud storage system, such that cloud storage cluster 122a is essentially indistinguishable to the data users 120 from file storage locations remote from the customer branch 104. Generally, the cloud storage cluster 122a will operate using a cloud storage operating system configured to interconnect and coordinate data storage across cloud storage clusters located at one or more additional locations, such as those discussed herein regarding network 100.

The customer data center 106 is typically at a location remote from the customer branch 104, and includes the customer's dedicated file storage resources, such as server farm 130, as well as additional data users 120. The customer data center 106 can also include a cloud storage cluster 122b which operates using a cloud storage operating system, and coordinates with cloud storage cluster 122a, and other cloud storage clusters (referred to herein as cloud storage clusters 122) to store and manage files for one or more customers.

The service provider data center 108 represents a data center accessible by one or more customers and controlled by a cloud service provider, and which is configured to provide cloud storage services for files controlled or accessed by those customers. In the embodiment shown, the service provider data center 108 includes one or more cloud storage clusters 122c, including controller and/or stripe nodes 140 and one or more virtual machine nodes 142, configured to be allowed to access by the various customers of a cloud service provider.

The hybrid customer/service provider data center 110 operates analogously to the service provider data center 108 including cloud storage cluster 122d, but could include resources co-owned by the customer and service provider, or separate equipment co-located at the same facility.

In various embodiments, one or more of the file locations may or may not be present, depending upon the particular configuration of the network 100. For example, a customer may elect to not have a dedicated customer data center 106, or a hybrid customer/service provider data center 110. The specific arrangement of file storage locations in network 100, although intended as exemplary, does not indicated that any one or more of such systems or locations would be required.

Generally, the network 100 represents an example of a network in which various types of cloud data services can be provided. As discussed above, this is an example of a network showing access by a customer of cloud file storage services. In such arrangements, typically customers have adopted a particular file storage system, including a file storage operating system, with which that customer locally manages file storage operations. Although customers typically use systems that have a baseline of common file management commands (e.g., read, open, write, release, stat, or other POSIX-compliant commands), they may have adopted a system that uses a subset of commands that are not part of a legacy or commonly-adopted set of commands. As such, when that customer elects to use a cloud storage solution of a particular cloud service provider, any commands the cloud service provider might make available are likely to not be coextensive with the customer's typically-used file I/O commands. As such, applications developed by the customer may not be useable with cloud storage services, or at least any advanced functions of the cloud storage provider may not be known or exposed to the customer (beyond the baseline POSIX-compliant commands that are widely available).

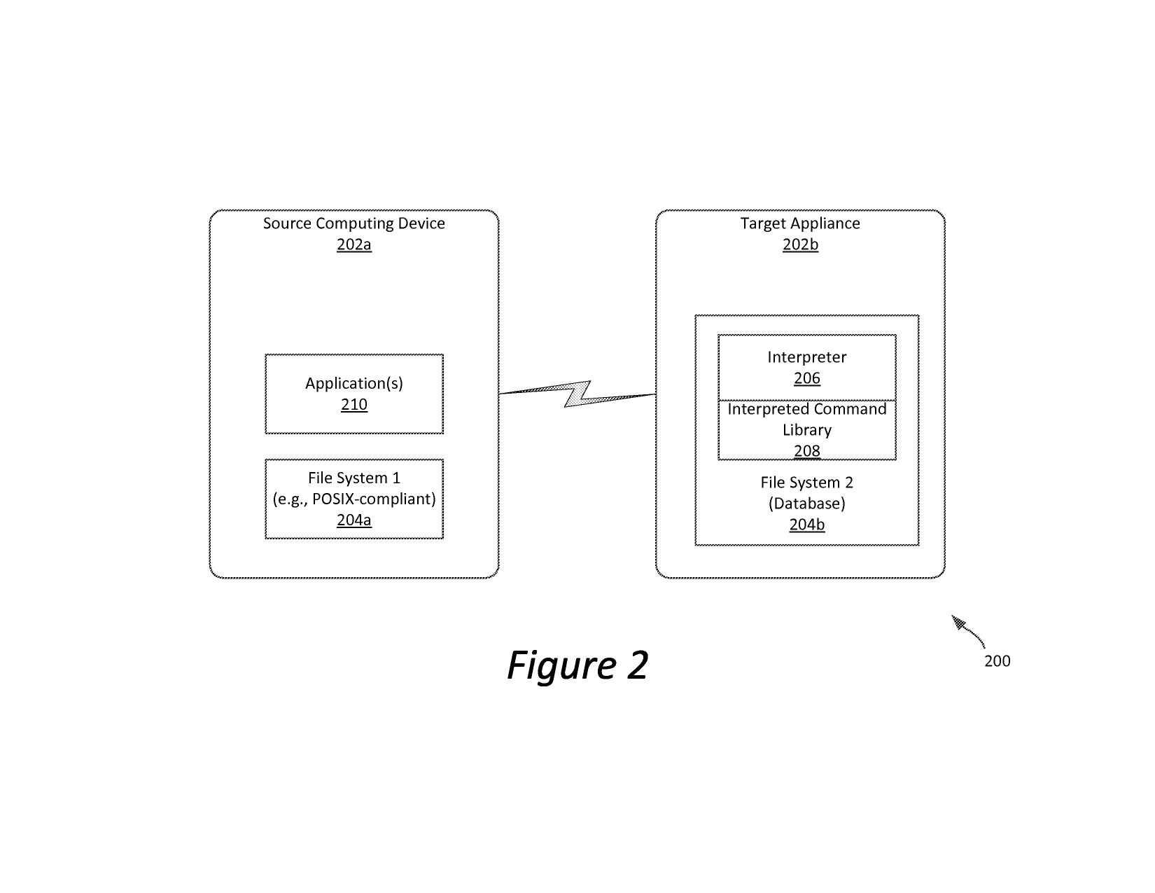

Referring now to FIG. 2, an example system 200 is illustrated in which a command API using legacy file I/O commands for file system management can be used to provide an extended selection of file system operations. In the embodiment shown, the system 200 illustrates a first computing system 202a and a second computing system 202b. In the embodiment shown, the first computing system 202a includes a first file system 204a, and the second computing system 202b includes a second file system 204b. In various embodiments, and as discussed above, in various embodiments the first file system 204a includes a set of legacy file I/O commands. In some embodiments, the first file system 204a is a POSIX-compliant file system supporting, for example, read, open, write, release, and stat commands.

In other embodiments, the first file system 204a rather represents a set of commands for managing execution using a particular standardized language, such as are made available via the hypertext transport protocol (HTTP). In such embodiments, the set of standardized, or legacy, commands, include GET, POST, HEAD, PUT, DELETE, TRACE, OPTIONS, or PATCH commands; other HTTP commands might be available as well.

In various embodiments of the present disclosure, the first and second computing systems 202a-b are communicatively connected (e.g., via the internet or dedicated data connection) such that command and files can be exchanged therebetween. In an example embodiment, the first and second computing systems 202a-b are interconnected via the internet.

The second computing system 202b can, in some embodiments, represent a storage appliance, such as a cloud storage appliance, maintained using a separate cloud storage operating system that supports a proprietary cloud storage file system. In such embodiments, file system 204b includes a number of “advanced” file management capabilities, such as data de-duplication, data protection, replication, content-addressable storage, file encryption, password and storage security key management, and write-once, read-many storage.

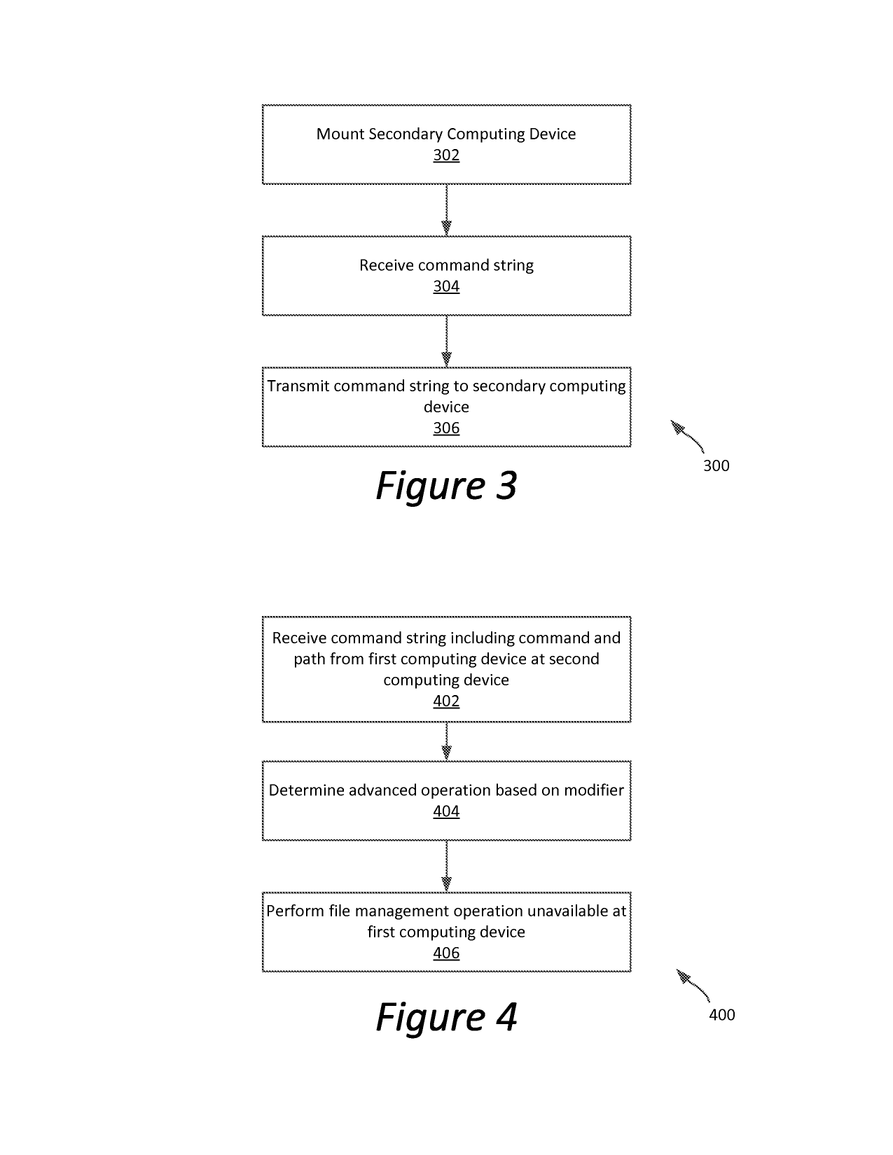

In various embodiments, the first and second computing systems 202a-b can have different, non-compatible file systems. For example, the first computing system 202a could be a Windows-based system, and could use a first file system 204a, such as a NTFS file system. Concurrently, the second computing system 202b could be a Linux-based file system, and could use a second file system 204b, such as an ext4 file system. In accordance with the present disclosure, commands executed from the first computing system 202a can, due to their being targeted toward files located on the second computing system 202b (or, generally present in a cloud-based system), result in execution of one of more of the “advanced” file management capabilities that would not otherwise be available as command son the first computing system. As further discussed below in connection with FIGS. 3-6, examples of such commands are provided, and can be performed within a command line interface or browser command.

As illustrated in FIG. 2, when the second computing system 202b receives a legacy file I/O command, an interpreter 206 can parse the received command, which typically will include the command, as well as a path (including one or both of a directory and filename) as well as optionally a modifier associated with the path which can assist in defining the particular file management command to be executed at the second computing system 202b. The interpreter 206 can access an interpreted command library 208, which can define a combination of legacy I/O commands, locations (e.g., paths), and modifiers, with which file operations in a cloud file operating system can be defined.

In accordance with the following disclosure, a user of either the first computing system 202a (e.g., a cloud storage customer) or the second computing system 202b (e.g., either a cloud storage customer or service provider) can define custom file management operations to be performed based on combined standard file operations, paths and modifiers, such that a user of the first computing system 202a can embed many “back-end” or cloud data management techniques in a manner that is enabled through use of standard file I/O operations at a source device; accordingly, the source device need not maintain specific commands for performing such advanced tasks, since combinations of standard I/O commands with. Additional details regarding management of file system operations are discussed below.

In some embodiments, the first computing system 202a can include one or more applications 210, configured to execute file I/O commands. Accordingly, applications 210 on the first computing system 202a can be configured to use POSIX-compliant commands (or other legacy I/O commands) for files located both on the first computing system 202a (and managed by first file system 204a) and on the second computing system 202b (and managed by second file system 204b), such that an expected result can occur within the application (e.g., reading or writing the file) while also incorporating additional file management features when the commands are directed to files managed by the second file system 204b.

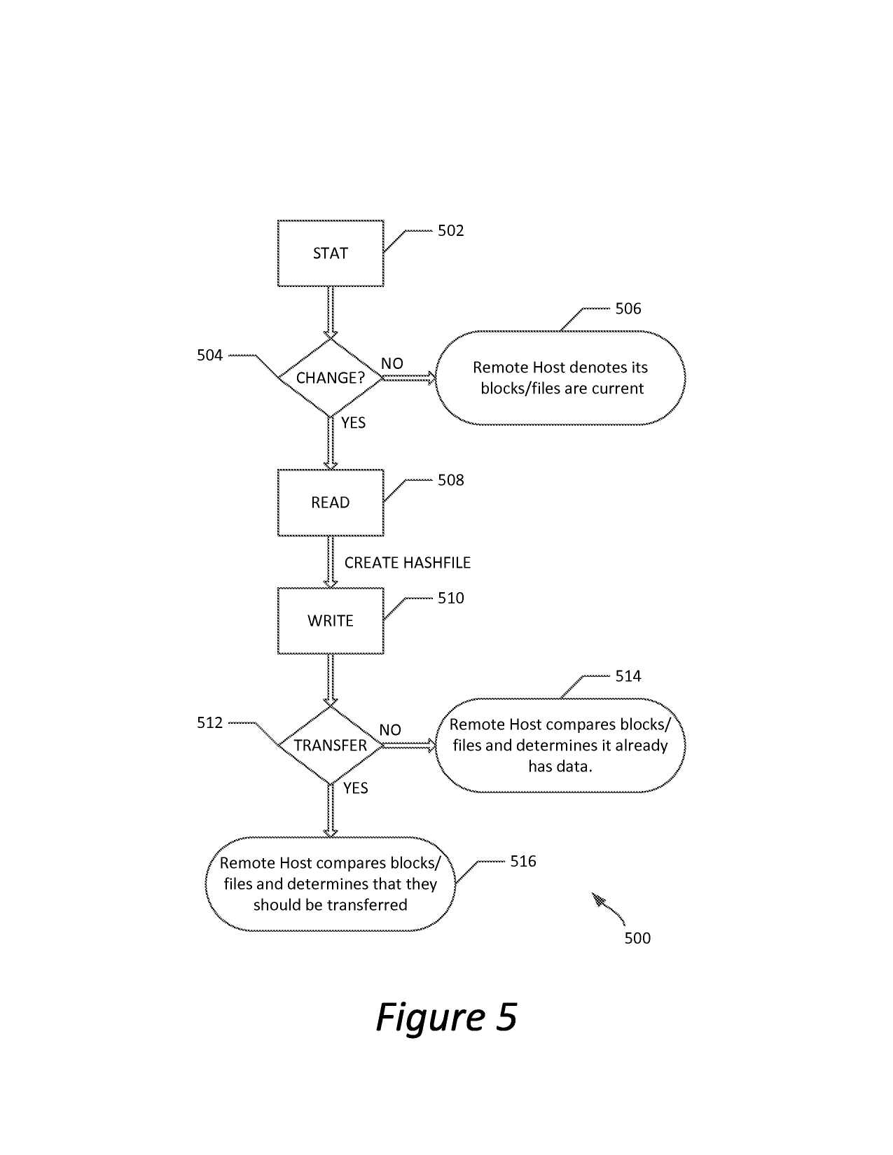

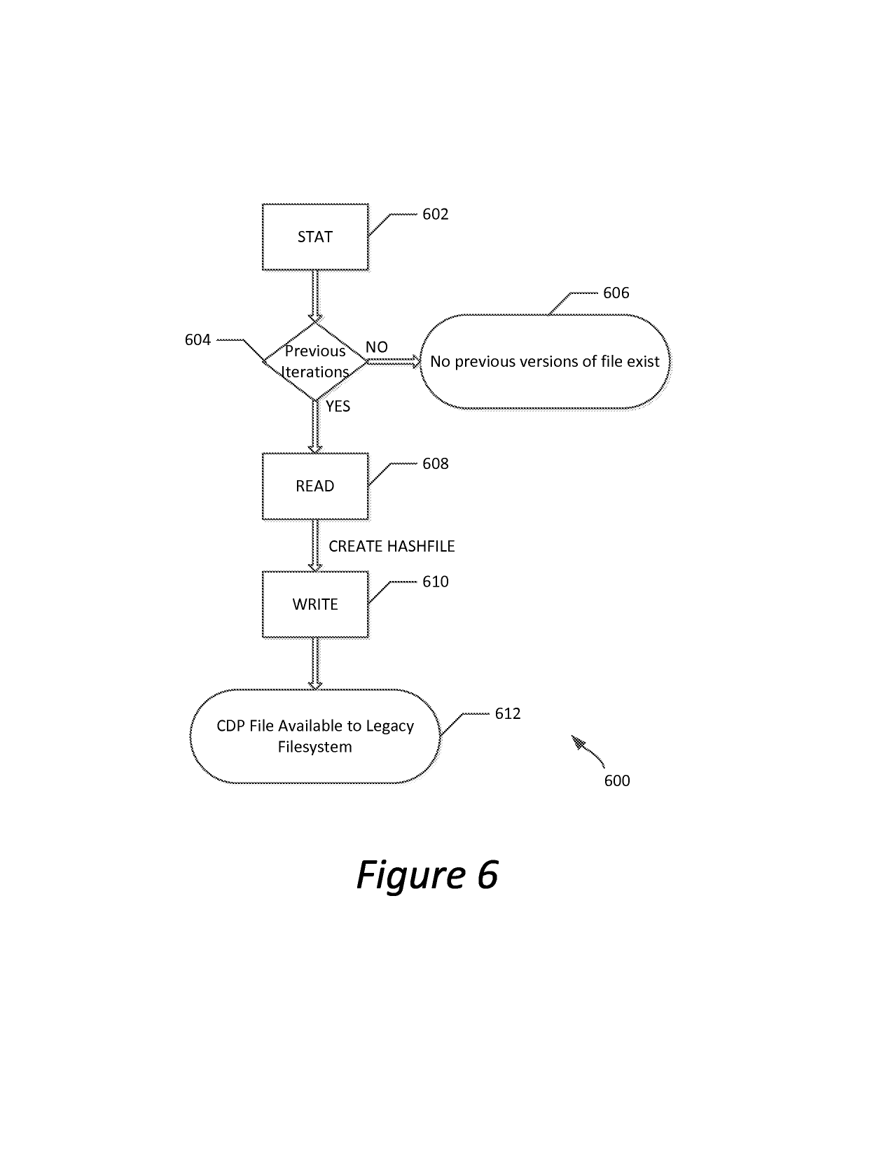

Referring now to FIGS. 3-6, flowcharts are illustrated providing examples of use of a system for managing files, and using legacy I/O commands to trigger non-legacy file management commands. FIGS. 3-4 represent generalized methods for transmission, receipt and execution management for such I/O commands; FIGS. 5-6 represent example “advanced” commands that can be received and performed, based on the method and systems as described herein.

FIG. 3 illustrates a method 300, which can be performed at a first, source computing system (e.g., computing system 202a), for implicating additional file management system functionality of a second, target computing system (e.g., computing system 202b). In the embodiment shown, the method 300 includes connecting to a target computing system, such as by mounting a volume of a target computing system for execution of file I/O commands relative to that system (step 302). In one example of such an operation in which a Linux-based operating system is used (i.e., that is POSIX-compliant), a root user can mount a volume on a remote system and then change the current directory to that new mount point:
root@user-desktop:/home/user# cd temp
root@user-desktop:/home/user/temp# cd mount

A user can then enter a particular command string (step 304), and the source computing system can transmit that command to the target computing system (step 306) for execution. In an example implementation, the command string includes a path (including directory and filename), and optionally a modifier. Based on the fact that the command is directed to the mounted volume, and because of the identity of the command, path, and modifier, one or more additional operations can be performed at the target computing device that would not otherwise be defined simply in the command entered in the command string. For example, a user can perform a standard command line function (e.g., “ls”) to list the contents of the directory:
root@user-desktop:/home/user/temp/mount# ls -la
drwxr-xr-x 2 root root 4096 Nov 2 19:02.

drwxr-xr-x 11 user user 4096 Nov 2 14:33..

drwxr-xr-x 2 user user 4096 Oct 14 16:27 Downloads

-rw-r--r-- 1 root root 3 Nov 2 19:02 test.txt

drwxr-xr-x 2 root root 4096 Nov 2 14:33.ybgid

drwxr-xr-x 2 root root 4096 Nov 2 14:33.ybpools

drwxr-xr-x 2 root root 4096 Nov 2 14:33.ybuid

In contrast, on the same target computing system, the same list command can be translated into an “advanced” I/O filesystem command by appending a string to the end of the filename of test.txt:
root@user-desktop:/home/user/temp/mount# ls test.txt.yb+blocksize pool

Appending the additional modifier string (the file extension .yb+) yields, in this instance, blocksize and pool functionality, which is typically not available in a standard is command. In another example where the basic command: cat is executed with the appropriate string appended to the filename, this command would be translated into yielding advanced meta information about the file:
root@user-desktop:/home/user/temp/mount# cat test.txt.yb+blocksize 1048576

In a still further example, using the basic command “echo”, the user can insert meta information into one or more virtual files on the target system:
root@user-desktop:/home/user/temp/mount# echo development>test.txt.yb+dept
root@user-desktop:/home/user/temp/mount# cat test.txt.yb+dept
root@user-desktop:/home/user/temp/mount# ls test.txt.yb+blocksize dept pool
   In these examples, advanced functions are performed by creating new virtual files with meta information, or modifying virtual files with additional extensions. An example of a file with a modified extension would be to append a string at the end of the file, which would denote a specific additional capability.

Referring now to FIG. 4, a flowchart of a method 400 is illustrated, for processing the received command as transmitted to a target computing device (e.g., computing device 202b). The method 400 includes receiving a command string at a computing device that includes a command and a path (step 402). This can include, for example, the “ls” or “echo” commands as discussed above. The method also includes determining an advanced operation to be performed at the target computing device based on the command, path, and modifier (step 404). For example, using the “yb+” modifier associated with the “ls” command, blocksize and pool functionality can be performed, or analogously meta-information could be inserted into a file using the “echo” command. An execution step performs the desired “advanced” command, including additional functionality, based on the command, path, and modifier (step 406).

It is noted that, in the “ls” and “echo” examples above, the blocksize and pool information, or insertion of meta-information, may not be available in a native ls or echo command on the computing system from which the command was issued. As such, it is the fact that the command was directed to a mounted volume managed using a different file system capable of receiving the command string and parsing that string to determine whether to execute additional command functionality that provides this additional feature.

In further reference to FIGS. 3-4, in addition to the command line references discussed herein, the methods and systems of the present disclosure can be further extended to websites and the associated markup language (HTML). Basic HTML commands such as GET and POST can be used similarly to read and write command line file I/O operations. Specifically, a user could use GET and POST references to implement aspects of WebDAV (Web Distributing and Authoring). WebDAV access control extensions provide an interoperable mechanism for handling access control for content and metadata managed by WebDAV servers. The underlying principle of access control is that who you are determines what operations you can perform on a resource. The “who you are” is defined by a “principal” identifier; users, client software, servers, and groups of the previous have principal identifiers. The “operations you can perform” are determined by a single “access control list” (ACL) associated with a resource. An ACL contains a set of “access control entries” (ACEs), where each ACE specifies a principal and a set of privileges that are either granted or denied to that principal. When a principal submits an operation (such as an HTTP or WebDAV method) to a resource for execution, the server evaluates the ACEs in the ACL to determine if the principal has permission for that operation.

All HTML basic commands such as GET and POST can be enhanced with the proposed methodology and furthermore ACL's for needs such as file “check-in” and “check-out” would not require add-ons such as WebDAV extensions. Again, a simple document could be furnished to developers showing how to access the virtual files and advanced meta information using basic commands.

Referring now to FIGS. 5-6, further examples of execution of additional file system functions are provided. FIG. 5 represents an example of executing data de-duplication on a target computing system (e.g., within a cloud operating system), thereby providing data de-duplication across systems using only basic file I/O commands. This type of source-based data de-duplication can be used for a variety of purposes: to keep multiple hosts synchronized, to save on bandwidth for communication to geographically diverse hosts over WAN links and/or for backup and archival purposes. As such, not only can a cloud-based file management system be supported for control by systems having incompatible file systems, they can exchange commands using known, legacy commands to perform more advanced data management techniques (e.g., data de-duplication or other functions).

As illustrated in the method 500 of FIG. 5, an application or command line could issue a stat command (step 502) to determine if a file has been modified since a previous event. In various embodiments, the stat command could be directed to a target computing system capable of supporting data deduplication, for example deduplication relative to files stored across one or more target computing systems, such as on a distributed cloud storage network (e.g., within network 100 of FIG. 1). At a first target computing system, a comparison operation could occur to determine if the file identified by the stat command has been modified (step 504). If the file has not been modified since the last event, the file can be deemed current (step 506). If the file has been modified, a read command (step 508) and a write command (step 510) can be used to generate a hash file. The hash file represents a state of the file being analyzed. In various embodiments, the hash file could be either viewable or hidden, but regardless would be compared to a reference file or virtual file to compare data across systems or storage areas (e.g., between the local file and the file on the target computing system) (step 512). This comparison generally occurs on a block level, to see if blocks within two files are unique, or might contain matching, existing data. If the data across two blocks matches in different files, then a file or database on a first system can be updated to become a pointer to the second set of data, since these blocks are in fact duplicates (step 514). If the data in one or more blocks of a particular file or database is not duplicative of the blocks or files on the source system, a data transfer can be performed to obtain the data at the target computing system that is non-duplicative, using the local file system at that device (step 516).

Referring now to FIG. 6, a flowchart of a method 600 for performing continuous data protection (CDP) on a target computing device in response to receiving a legacy file I/O command, is shown. In general, CDP is a method of storing previous iterations of files in order to “roll-back the clock”, perhaps for backup and archival purposes. In method 600, a first system (e.g., a computing system 202a) can be configured to execute a stat command periodically (e.g., hourly) on a particular data file on a remote system (e.g., computing system 202b) (step 602). Based on the stat command, the target system can detect whether previous iterations of the file exist (step 604). If the file has no previous iterations, the target system will note that no other version of the file exists for access and rollback (step 606). If previous iterations exist, the target system will perform a read of the file and write a hashed version of the file alongside a timestamp, on either the target system or the source system (steps 608-612).

In further reference to FIGS. 5-6, an ISV can leverage the file/pathname modifiers to create their own set of application functions and interfaces on a target computing device. For example, an ERP software vendor can easily integrate backup and disaster recovery controls from within their software, for example by performing various CDP processes and storing results of such processes. In a second example, an ISV who creates Content Distribution solutions can allow their users to leverage the data deduplication and replication capabilities from within their own software to keep a vast number of remote sites over distant geographies in sync with each other. Other possibilities exist as well.

Referring generally to FIGS. 3-6, as seen in the above examples, use of legacy file I/O commands to perform advanced file management operations that are not specifically supported in the set of legacy commands provides a number of advantages. For example, the above commands provide just one set of examples how using the command line interface (CLI) of a legacy POSIX OS can have access to advanced commands without the need for extending the base commands through custom applications—in addition, scripts or applications leveraging basic commands that allow access to the virtual files and advanced meta information for a number of purposes can be written in any programming language, obviating the need for a specific SDK that prescribes a particular language and methodology of interfacing with a remote system to provide advanced capabilities (including but not limited to data de-duplication, replication, cdp, etc). A simple document could be furnished to developers showing how to access the virtual files and advanced meta information. This documentation could even be embedded as a virtual file or meta information or a man-page.

Additionally, using the methodology disclosed herein, it is expected that many ISV (Independent Software Vendors) will be more inclined to integrate their solutions than with many other providers of advanced capabilities (such as data de-duplication, replication, CDP, Content Addressable Storage, etc.). Specifically, the methods and systems described herein reduce the need for proprietary APIs and allow ISVs to use whichever programming language they choose. Furthermore, it allows those ISVs to use the very basic file system commands that are well documented and supported.

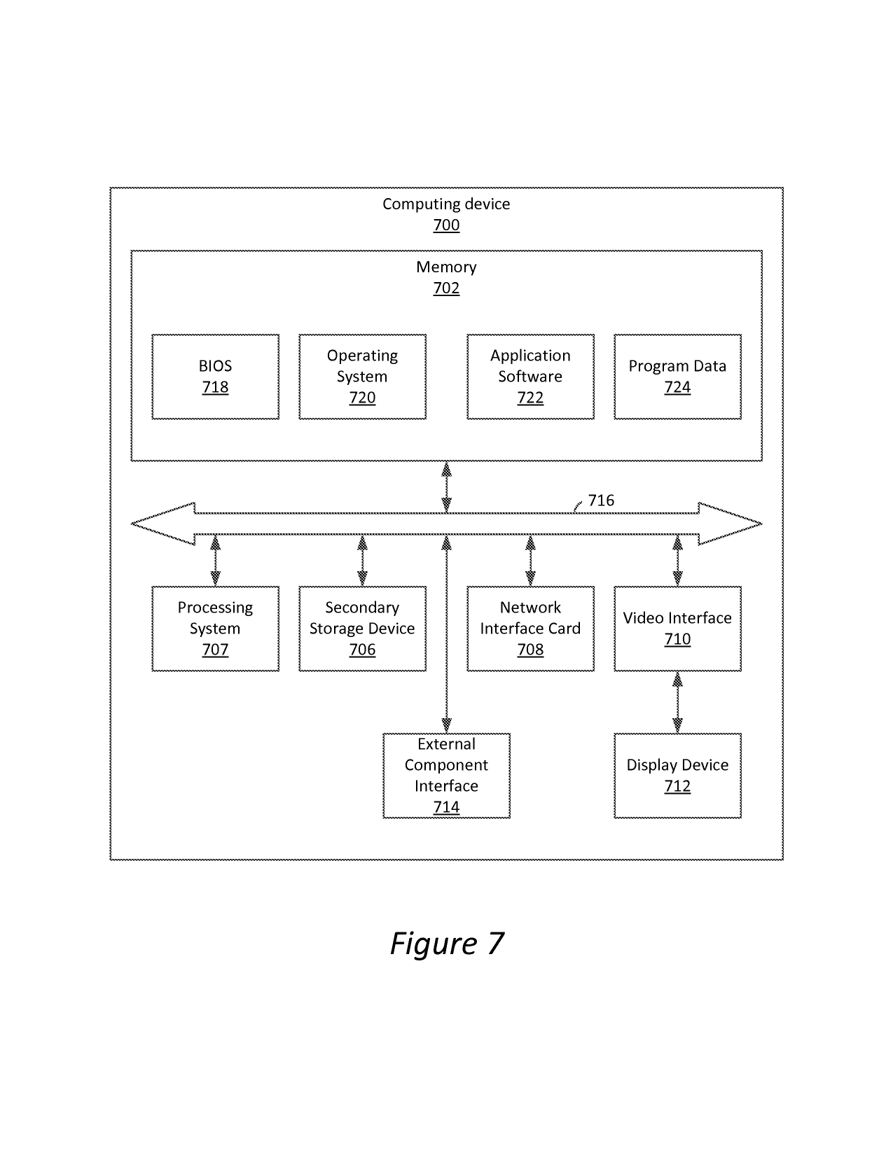

Referring now to FIG. 7, a block diagram illustrating an example computing device 700 is shown, which can be used to implement aspects of the present disclosure. In particular, the computing device 700 can represent any of a variety of computing devices such as those illustrated in FIGS. 1-2.

In the example of FIG. 7, the computing device 700 includes a memory 702, a processing system 704, a secondary storage device 706, a network interface card 708, a video interface 710, a display unit 712, an external component interface 714, and a communication medium 716. The memory 702 includes one or more computer storage media capable of storing data and/or instructions. In different embodiments, the memory 702 is implemented in different ways. For example, the memory 702 can be implemented using various types of computer storage media.

The processing system 704 includes one or more processing units. A processing unit is a physical device or article of manufacture comprising one or more integrated circuits that selectively execute software instructions. In various embodiments, the processing system 704 is implemented in various ways. For example, the processing system 704 can be implemented as one or more processing cores. In another example, the processing system 704 can include one or more separate microprocessors. In yet another example embodiment, the processing system 704 can include an application-specific integrated circuit (ASIC) that provides specific functionality. In yet another example, the processing system 704 provides specific functionality by using an ASIC and by executing computer-executable instructions.

The secondary storage device 706 includes one or more computer storage media. The secondary storage device 706 stores data and software instructions not directly accessible by the processing system 704. In other words, the processing system 704 performs an I/O operation to retrieve data and/or software instructions from the secondary storage device 706. In various embodiments, the secondary storage device 706 includes various types of computer storage media. For example, the secondary storage device 706 can include one or more magnetic disks, magnetic tape drives, optical discs, solid state memory devices, and/or other types of computer storage media.

The network interface card 708 enables the computing device 700 to send data to and receive data from a communication network. In different embodiments, the network interface card 708 is implemented in different ways. For example, the network interface card 708 can be implemented as an Ethernet interface, a token-ring network interface, a fiber optic network interface, a wireless network interface (e.g., Wi-Fi, WiMax, etc.), or another type of network interface.

The video interface 710 enables the computing device 700 to output video information to the display unit 712. The display unit 712 can be various types of devices for displaying video information, such as a cathode-ray tube display, an LCD display panel, a plasma screen display panel, a touch-sensitive display panel, an LED screen, or a projector. The video interface 710 can communicate with the display unit 712 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 714 enables the computing device 700 to communicate with external devices. For example, the external component interface 714 can be a USB interface, a FireWire interface, a serial port interface, a parallel port interface, a PS/2 interface, and/or another type of interface that enables the computing device 700 to communicate with external devices. In various embodiments, the external component interface 714 enables the computing device 700 to communicate with various external components, such as external storage devices, input devices, speakers, modems, media player docks, other computing devices, scanners, digital cameras, and fingerprint readers.

The communications medium 716 facilitates communication among the hardware components of the computing device 700. In the example of FIG. 7, the communications medium 716 facilitates communication among the memory 702, the processing system 704, the secondary storage device 706, the network interface card 708, the video interface 710, and the external component interface 714. The communications medium 716 can be implemented in various ways. For example, the communications medium 716 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 702 stores various types of data and/or software instructions. For instance, in the example of FIG. 7, the memory 702 stores a Basic Input/Output System (BIOS) 718 and an operating system 720. The BIOS 718 includes a set of computer-executable instructions that, when executed by the processing system 704, cause the computing device 700 to boot up. The operating system 720 includes a set of computer-executable instructions that, when executed by the processing system 704, cause the computing device 700 to provide an operating system that coordinates the activities and sharing of resources of the computing device 700. Furthermore, the memory 702 stores application software 722. The application software 722 includes computer-executable instructions, that when executed by the processing system 704, cause the computing device 700 to provide one or more applications. The memory 702 also stores program data 724. The program data 724 is data used by programs that execute on the computing device 700.

Although particular features are discussed herein as included within an electronic computing device 700, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, DDR4 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. In embodiments of the present disclosure, computer storage media excludes transitory signals.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The above specification, examples and data provide a complete description of the manufacture and use of the composition of the invention. Since many embodiments of the invention can be made without departing from the spirit and scope of the invention, the invention resides in the claims hereinafter appended.

1. A method comprising:
receiving from a first computing device at a target computing device a command string, the command string including a command and a path, the command defined in a set of commands recognizable on the first computing device and the path associated with the command and indicating execution on the target computing device, the path including a modifier;
in response to receiving the command string, interpreting the command as a second command recognizable on the target computing device but not provided by a set of command supported by the first computing device, the second command defined at least in part by the modifier; and
performing the second command at the target computing device.

2. The method of claim 1, wherein the command comprises a stat command and the path includes a name of a file, and wherein, in response to receiving the command string, the one or more file management operations include:
determining whether the file has been modified within a predetermined period of time;
upon determining that the file has been modified, generating a hash file representing a state of the file; and
comparing the hash file to a reference file to detect existence of a duplicate file.

3. The method of claim 1, wherein the path comprises a filename, and wherein the modifier is appended to a filename.

4. The method of claim 1, wherein the path directs execution of the command to the target computing device.

5. The method of claim 1, wherein the path is included within the command string.

6. The method of claim 1, wherein the command string comprises a file I/O command string.

7. The method of claim 1, wherein the command string comprises an HTML command.

8. The method of claim 7, wherein the HTML command is selected from a group of HTML commands consisting of:
a GET command;
a POST command;
a HEAD command;
a PUT command;
a DELETE command;
a TRACE command;
an OPTIONS command; and
a PATCH command.

9. The method of claim 1, wherein the one or more file management operations are selected from a group of advanced file management operations consisting of:
data de-duplication;
data protection;
replication;
content-addressable storage;
file encryption;
password and storage security key management; and
write-once, read-many storage.

10. The method of claim 1, wherein the first computing device operates using a legacy file system.

11. The method of claim 10, wherein the legacy file system is a POSIX-compliant file system.

12. The method of claim 1, wherein the set of commands recognizable on the first computing device includes one or more file I/O commands selected from the group of commands consisting of:
a read command;
a write command;
an open command;
a release command; and
a stat command.

13. The method of claim 1, wherein the target computing device receives the file I/O command string from an application executing on the first computing device.

14. A method comprising:
transmitting from a first computing device to a target computing device a command string, the command string including a command and a path, the command defined in a set of commands recognizable on the first computing device and the path associated with the command and indicating execution on the target computing device, the path including a modifier;
whereby the target computing device interprets the command string as a second command and executes the second command, the second command defined at least in part by the modifier and representing one or more file management operations not provided by a set of commands supported by the first computing device.

15. The method of claim 14, further comprising, prior to receiving the file I/O command string at the target computing device, attaching a file system of the target computing device to a file tree managed at the first computing device.

16. The method of claim 14, wherein attaching the file system is performed using a mount command on the first computing device referencing a file system on the target computing device.

17. A computerized system comprising:
a target computing device communicatively interconnected to a first computing device having a memory organized according to a file system, the file system defining a plurality of file I/O commands including a read command, a write command, an open command, a release command, and a stat command, the target computing device configured to receive one or more command strings including one or more of the plurality of file I/O commands and an associated modifier associated with a path defined on the first computing device defining a directory location on the target computing device, the target computing device including a second file system including one or more operations not provided by the commands supported by the first computing device, the one or more operations executed by the target computing device in response to receipt of the one or more of the plurality of file I/O commands and associated modifier.

18. The computerized system of claim 17, further comprising the first computing device.

19. The computerized system of claim 17, wherein the modifier comprises a string appended to a filename that is a target of the one or more file I/O commands in the command string.

20. The computerized system of claim 17, wherein the modifier comprises a string appended to a path included in the one or more file I/O commands, the path defining a location on the target computing device.

21. The computerized system of claim 17, wherein the first computing device operates using a legacy file system.
